(19) United States
(12) Patent Application Publication
(10) Pub. No.: US 2005/0085249 A1
(43) Pub. Date: Apr. 21, 2005

(54) Method, apparatus and system for pilotless frequency offset compensation in multipoint-to-point wireless systems with OFDM

(75) Inventors: Yuri Goldstein, Southbury, CT (US); Yuri Okunev, Southbury, CT (US)

Correspondence Address: GORDON & JACOBSON, P.C., 60 LONG RIDGE ROAD, SUITE 407, STAMFORD, CT, 06902, US

(73) Assignee: PCTEL, Inc.

(21) Appl. No.: 10/685,615

(22) Filed: Oct. 16, 2003

(51) Int. Cl. H04B 1/00; H04B 15/00; H04B 7/00; H04B 7/005

(52) U.S. Cl. 455/502; 455/63.1; 455/69; 455/70

(57) ABSTRACT

Apparatus, methods and systems for frequency offset compensation in multipoint-to-point orthogonal frequency division multiplexing (OFDM) systems are provided. In the hub, frequency offset estimates are made in the frequency domain for each group of carriers of the OFDM system. The hub then transmits indications (parameters) of the frequency offset for each group of carriers to the nodes. Frequency offset compensation is then accomplished in each node, preferably in the time domain.

This application is related to co-invented, co-owned U.S. Ser. No. 10/342,519 filed Jan. 15, 2003, Ser. No. 10/406,776 filed Apr. 3, 2003, Ser. No. 10/628,943 filed Jul. 29, 2003, and Ser. No. 10/638,980 filed Aug. 12, 2003, all of which are hereby incorporated by reference herein in their entireties.

### BACKGROUND OF THE INVENTION

1. Field of the Invention

The present invention relates broadly to telecommunications and data transmission via multiple telecommunication channels. The present invention more particularly relates to wireless telecommunication systems operating in radio channels with variable parameters. Specifically, the invention relates to multipoint-to-point (MPTP) wireless systems and networks with multicarrier orthogonal frequency division multiplexing (OFDM).

2. State of the Art

OFDM technology has well-known uses in a wide variety of wire and wireless telecommunication systems. The OFDM technique distributes and transmits data synchronously over a large number of carriers that are spaced apart at precise frequencies. OFDM is one of the most spectrally efficient transmission techniques. Among other advantages, multicarrier OFDM systems have a much lower symbol rate than equivalent single carrier systems.

In wireless channels, OFDM allows a system to mitigate the effects of multipath propagation and to provide a high data rate in the multipath environment. This technology is a basis for the Wireless Local Area Network (WLAN) IEEE.802.11a and IEEE.802.11g standards in the 5 GHz and 2.4 GHz frequency bands, respectively. According to the standards, the 52-carrier system provides up to 54 Mbit/s within a 20 MHz bandwidth in a multipath environment with path delays up to 800 nanoseconds (ns). OFDM technology is recommended in an IEEE 802.16 draft standard for fixed broadband wireless access systems in the frequency range 2-11 Ghz. The draft standard considers utilization of hundreds or even thousands of orthogonal carriers with QAM modulation. OFDM is also considered as a promising candidate for WLAN implementation in the 60 GHz frequency band as well as for 3G mobile wireless systems.

Typical OFDM applications are point-to-point and point-to-multipoint (PTMP) transmissions. A point-to-multipoint application is illustrated in FIG. 1 where a central station (hub) and N user stations (nodes) are shown. The central station may be a base station (BS) in a mobile or fixed wireless network, or it may be an access point (AP) in a WLAN. The nodes may be any individual devices of the wireless network. For example, in the WLAN environment a node may be a PC, a laptop computer, a printer, a VoIP cordless phone, etc. Transmitted signals in the frequency domain are schematically shown at the bottom of FIG. 1 and consist of M carriers, numerated in the figure from 1 to M.

The key feature of the point-to-multipoint OFDM application is that the Hub sends a signal to all nodes simultaneously (in parallel), but only one of the nodes can transmit signal within the current time interval. FIG. 1 shows the example in which only the i-th node is currently transmitting a signal to the Hub, and only the i-th node is allowed to use carriers for data transmission at the given moment. The active node can utilize the set of all carriers or any subset of carriers, but no other user can transmit any carrier at the same time. Practically this means that the system utilizes a type of time division access protocol, e.g., regular time division multiple access (TDMA) or random channel access based on carrier sense multiple access (CSMA). In other words, in PTMP applications, the nodes transmit their data within different, non-overlapping time intervals.

Point-to-multipoint OFDM transmission has the benefit of permitting the system to avoid the problems of differences in signal powers, frequency offsets and time delays for signals received from different nodes, because at any moment the receiver processes the signal from a single transmitter only. Therefore, the existing WLAN IEEE 802.11 standards support only point-to-multipoint transmission. Even with an ad hoc mode when there is no centralized controller-hub and one of the nodes provides the function of a temporary hub, the IEEE standard allows transmitting the signal only from one single transmitter at any moment.

On the other hand, the point-to-multipoint mode cannot efficiently exploit system capacity. For example, consider a VOIP cordless phone as one of the nodes which does not need a high data rate but which requires a high quality digital voice transmission in real time. In this situation, when the cordless phone is active, it uses only a small part of the system capacity and forces all other nodes to wait for it to get off the air.

One possible way to increase the efficiency of OFDM utilization in a multi-user network is a multipoint-to-point (MPTP) mode that allows the nodes to transmit data simultaneously using a part of the system capacity for each node. This approach is considered for WLAN applications based on the IEEE 802.11a standard in McFarland, B. et al., “The 5-UP Protocol for Unified Multiservice Wireless Networks”, IEEE Communications, Vol.39, No. 11, November, 2001. A multipoint-to-point mode is illustrated in FIG. 2, which contains the same Hub and N nodes as in FIG. 1.

The principal difference between multipoint-to-point OFDM and point-to-multipoint OFDM is that in multipoint-to-point OFDM all nodes have opportunity to send signal to the Hub simultaneously (in parallel) using the corresponding parts of a carrier set. As shown in the example of FIG. 2, the first node (e.g., a cordless phone) transmits its data on the first carrier, the second node transmits on the second and (M-5)-th carrier, and so on. Distribution of carriers between the nodes is a function of the hub. Practically, this distribution, based on node demands, transforms the OFDM technique into the orthogonal frequency division multiple access (OFDMA) method.

In a real WLAN environment, OFDMA technology should be combined with some type of time division multiple access (TDMA). For example, if all carriers are currently distributed and used within a subset of nodes and some additional nodes demand communication, the system must assign some group of carriers for two or even more nodes, and these nodes will use the carriers in a time division mode.

OFDMA is an extended OFDM technique that provides the most efficient exploitation of the multicarrier system capacity. However, OFDMA has several additional issues as compared to the traditional point-to-multipoint OFDM. At the physical layer, all these issues are the result of differences in signal transformation and the propagation in paths from each individual node to the hub. As a result, groups of carriers associated with different nodes have different powers, different frequency offsets, and different time delays. In addition, each carrier may have its own individual phase shift. The corresponding issues can thus be formulated as follows: 1) Power control for carrier groups; 2) Frequency offset compensation for carrier groups; 3) Individual carrier phase shift tracking; and 4) Time delay compensation for carrier groups.

A general approach to a solution of the above issues is described in McFarland, B. et al., “The 5-UP Protocol for Unified Multiservice Wireless Networks”, IEEE Communications, Vol.39, No.11, November 2001. However, this paper does not contain any details allowing a real implementation of the system.

Methods and apparatus for power control in MPTP OFDM systems (issue #1 above) based on data carrier duplication were described in previously incorporated U.S. Ser. No. 10/342,519 entitled “Method, Apparatus and System for OFDM Power Control”. In addition, pilotless methods, apparatus and systems for frequency offset and phase shift tracking based on phase correction in the frequency domain (after FFT) in the hub receiver (issue #2 above) were proposed in previously incorporated U.S. Ser. No. 10/628,943 entitled “Pilotless, Wireless, Telecommunications Apparatus, Systems and Methods”. However, neither of those disclosures provided a solution to frequency offset compensation for carrier groups in MPTP OFDM as the methods of frequency offset compensation disclosed in U.S. Ser. No. 10/628,943 only partly solves the problem. The fact is that in the OFDM systems the frequency offset causes both carrier phase shifts and violation of carrier orthogonality. Violation of carrier orthogonality, in turn, causes considerable intercarrier interference. The disclosed algorithms in the previously incorporated patent applications provide phase shift compensation in frequency domain (after FFT), but they do not eliminate the intercarrier interference in the FFT.

On the other hand, if all carriers are utilized by one single node, then common frequency offset may be compensated in the hub receiver in the time domain, i.e. before FFT, to avoid the intercarrier interference. This approach is also disclosed in previously incorporated U.S. Ser. No. 10/628,943 for point-to-multipoint applications. However, when different nodes use different groups (subsets) of carriers simultaneously, and these groups have different frequency offsets, then compensation of frequency offset in the receiver in time domain is impossible.

One important aspect of frequency offset compensation in MPTP OFDM systems is that the problem is preferably solved on the basis of a “pilotless” approach; i.e., without the use of pilot carriers during data transmission. The pilotless approach allows a system to increase its real capacity. Moreover, while a point-to-multipoint system could in principle use fixed carriers as pilots, a MPTP pilot system needs at least one pilot carrier for each carrier group; and with respect to a flexible MPTP system, since the carrier group configuration may be changed from session to session, and the number of carriers within each groups is variable (from one carrier to the maximum possible carriers), the pilot approach is not a practical one for a flexible MPTP system implementation.

It should be appreciated that two types of pilot signals are usually used in wireless systems: preamble pilots which are transmitted during preamble before data transmission, and accompanying pilots which are transmitted during the whole communication session in parallel with data transmission. In accord with the present invention, a pilotless approach permits use of the preamble pilots but does not utilize the accompanying pilots during data transmission at all.

In the context of the frequency offset problem, the preamble pilots provide rough compensation of the initial frequency offset. For example, if a typical frequency instability is equal to 20 ppm, then, in the frequency range 5 GHz, an up to 100 kHz frequency offset may be experienced. If the frequency interval between adjacent carriers is about 200-300 kHz, this offset cannot be compensated for during data transmission because the receiver is not capable to distinguish non-orthogonal carriers. So, for MPTP OFDM systems, the initial frequency offset should be compensated for in each transmitter within the initialization stage of the communication session (handshake). This initial compensation procedure, however, is outside the scope of the present invention. Nonetheless, even if frequency offsets are partially compensated during the handshake, the MPTP OFDM system must provide precise frequency offset compensation during the communication session in order to provide perfect coherent signal processing. This precise frequency offset compensation is an important part of MPTP OFDM system design.

### SUMMARY OF THE INVENTION

It is therefore object of the invention to provide multipoint-to-point, multicarrier, wireless, pilotless telecommunication systems, apparatus and methods which implement precise frequency offset compensation for carrier groups associated with different users.

It is an additional object of the invention to provide methods for the estimation of frequency offsets for carrier groups in the hub receivers of multipoint-to-point, multicarrier, wireless, pilotless telecommunication systems.

It is a further object of the invention to provide simply implementable algorithms and apparatus for estimation of frequency offsets for carrier groups in the hub receiver of a multipoint-to-point, multicarrier, wireless pilotless telecommunication system.

It is another object of the invention to provide methods for determining desired parameters of the frequency offsets for carrier groups, which should be transmitted from the hub to user nodes for the corresponding frequency offset correction in user transmitters.

An additional object of the invention is to provide algorithms and apparatus for frequency offset compensation in the user transmitters of multipoint-to-point, multicarrier, wireless, pilotless telecommunication systems. A further object of the present invention is to provide multipoint-to-point, multicarrier, wireless, pilotless telecommunication systems, apparatus and methods which combine OFDMA and TDMA technologies to provide an efficient utilization of system capacity in a multiuser environment.

In accord with these objects, which will be discussed in detail below, the present invention provides methods, apparatus and systems for compensation of frequency offsets for carrier groups in the multipoint-to-point (MPTP), multicarrier OFDM, wireless, pilotless telecommunication systems. Broadly, the methods of the invention for implementing frequency offset compensation in the MPTP OFDM systems includes: in the hub receiver, estimating frequency offset for each group of carriers in the frequency domain (after FFT); transmitting the frequency offset parameters for each group of carriers from the hub to the nodes; and in each node transmitter implementing frequency offset compensation in the time domain (after IFFT).

According to one aspect of the invention, algorithms of frequency offset estimation for groups of carriers are provided and are utilized by the hub receiver to support data transmission from nodes to the hub. The algorithms are based on reducing quadrature components or differential quadrature components of the received carriers and averaging the reduced components in two-dimensional space for K carriers within the group and for N symbols of each carrier. The reduction procedure involves all carriers utilized in the system and is not dependent on their combining in the groups. The averaging procedure on the other hand is carried out separately for each carrier group participating in the session.

According to another aspect of the invention, simplified algorithms of frequency offset estimation are provided for groups of carriers. The simplified algorithms are based on utilization of a simple reference vector as well as on a majority vote algorithm which allows reduced components to be replaced with their signs. Replacement of the reduced components by their signs provides some mitigation of the effect of wrong decisions, because in this case any wrong decision cannot dramatically change the result. Additional robustness of simplified algorithms is achieved by using a lower bound for majority votes: if majority votes are less than some predetermined threshold, no corrections are provided.

Proposed estimates of frequency offsets are finally expressed preferably as sine and cosine functions of the phase shift caused by the frequency offset. These functions as well as any their transformations may be considered as the desired parameters of the frequency offset for the corresponding group of carriers. According to the invention, these parameters are transmitted from the hub to the node as a hub instruction for current frequency correction.

According to another aspect of the invention, the frequency offset compensation in the MPTP OFDM systems is provided in each node transmitter. In particular, during a current telecommunication session with the hub, each node compensates its frequency offset as indicated by the hub by means of signal correction in the frequency and/or time domains. According to a preferred embodiment of the invention, frequency offset compensation is accomplished in the time domain based on linear transformation of complex samples of a signal at the output of the IFFT in the transmitter. Frequency offset compensation in the time domain after IFFT is the preferred method for digital implementation of the OFDM.

In accord with yet another aspect of the invention, the MPTP OFDM system of the invention is provided with an OFDMA/TDMA mode. In the MPTP OFDM system with combined OFDMA/TDMA mode, if the system capacity is sufficient to satisfy all current demands of the nodes in data transmission, then carriers are distributed within the nodes, and pure OFDMA mode is provided (using frequency offset compensation per carrier group according to other aspects of the invention). If the system capacity is not sufficient to satisfy all current demands of the nodes in data transmission, then a group of carriers is assigned to two or more nodes, and the nodes utilize the group of carriers within non-overlapped time intervals according to any type of TDMA mode.

### BRIEF DESCRIPTION OF THE DRAWINGS

FIG. 1 is a high level schematic diagram of an OFDM point-to-multipoint mode telecommunication system of the prior art.

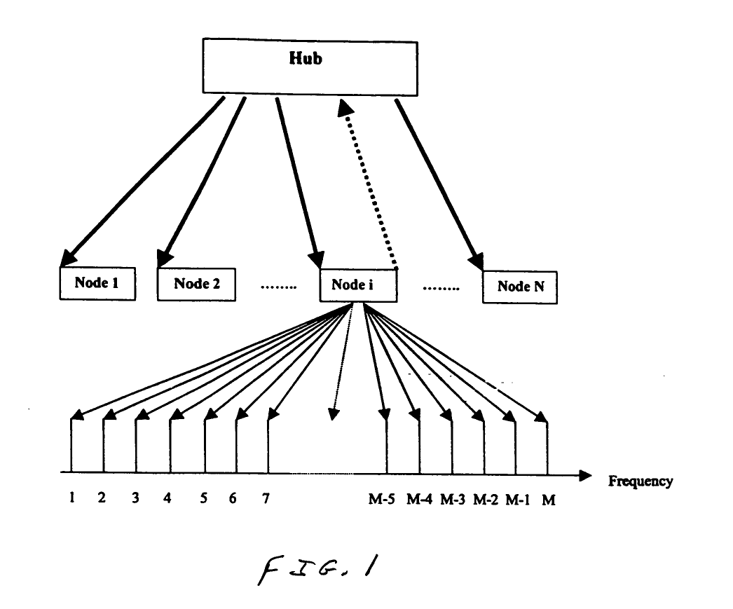

FIG. 2 is a high level schematic diagram of an OFDM multipoint-to-point mode telecommunication system of the prior art.

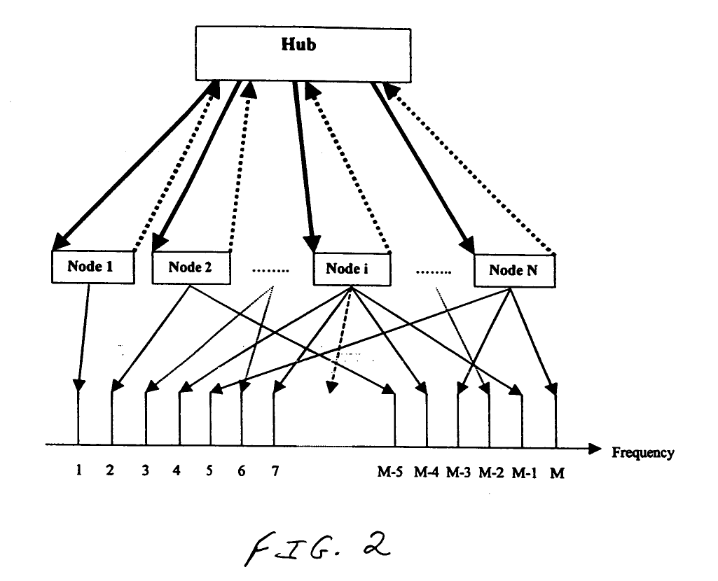

FIG. 3 is a high level schematic diagram of the proposed multipoint-to-point (MPTP) OFDM system with frequency offset compensation.

FIG. 4 is a detailed schematic diagram of the Hub-site of the proposed MPTP OFDM system, including frequency offset estimation procedure for the carrier groups, based on differential quadrature components of the received carriers.

FIG. 5 is a detailed schematic diagram of the Hub-site of the proposed MPTP OFDM system, providing simplified frequency offset estimation procedure for the carrier groups, based on the majority algorithm.

FIG. 6 is a detailed schematic diagram of the User-site of the proposed MPTP OFDM system, providing frequency offset compensation in time domain for the carrier group in the node transmitter.

### DETAILED DESCRIPTION OF THE PREFERRED EMBODIMENT

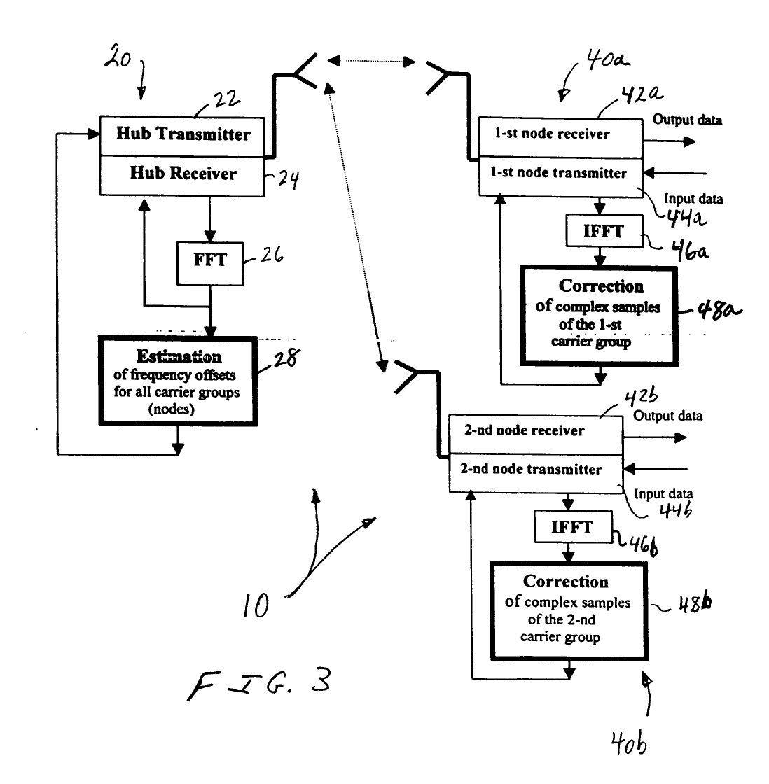

Turning now to FIG. 3, a high-level block diagram of a multipoint-to-point OFDM system 10 according to the invention is seen. The system 10 implements frequency offset compensation as will be described hereinafter. The system 10 is comprised of a hub 20 and a plurality of nodes (two shown) 40a, 40b. The hub includes a hub transmitter 22, a hub receiver 24, and a fast Fourier transform block 26 and an estimation block 28 which may be considered as part of the hub receiver. Each of the plurality of nodes 40a, 40b includes a node receiver 42a, 42b, a node transmitter 44a, 44b, and an inverse fast Fourier transform block 46a, 46b and a correction block 48a, 48b which may be considered as part of the node transmitter.

In the MPTP OFDM system of the invention, each node (user) 40 has the opportunity to transmit data using a group of carriers (the “group” being as small as a single carrier and as large as all carriers), depending on its data rate demand and assignment from the hub 20. If all carriers were to be utilized by a single node, then a common frequency offset could be compensated for in the hub receiver in the time domain, i.e., before use of the FFT. In this case, the compensation algorithm is described as follows: Let Sₘ be the m-th complex sample of the received multicarrier symbol, frequency shifted by Δf Hz, where m is an integer changing from 1 to M, and M is the number of carriers in the multicarrier OFDM signal; then, the m-th sample of the compensated (frequency unshifted) signal S_{mc} is the complex number defined by
S_{mc}=Sₘ exp(−jmφ) (1.1)
where φ=2πΔfT, and T is an FFT interval (interval of OFDM orthogonality).

However, when different nodes use different groups (subsets) of carriers simultaneously, and these groups have different frequency offsets, then compensation of frequency offset in the receiver in the time domain is impossible. In this case, and in accord with the invention, the compensation procedure is transferred to the transmitting nodes 40 which are correspondingly informed by the hub 20 regarding values of the frequency shifts within the carrier groups. In any individual node providing data transmission on a specified group of carriers, the samples at the output of the IFFT 46 of the node should be corrected by the correction block 48 as required by the hub 20.

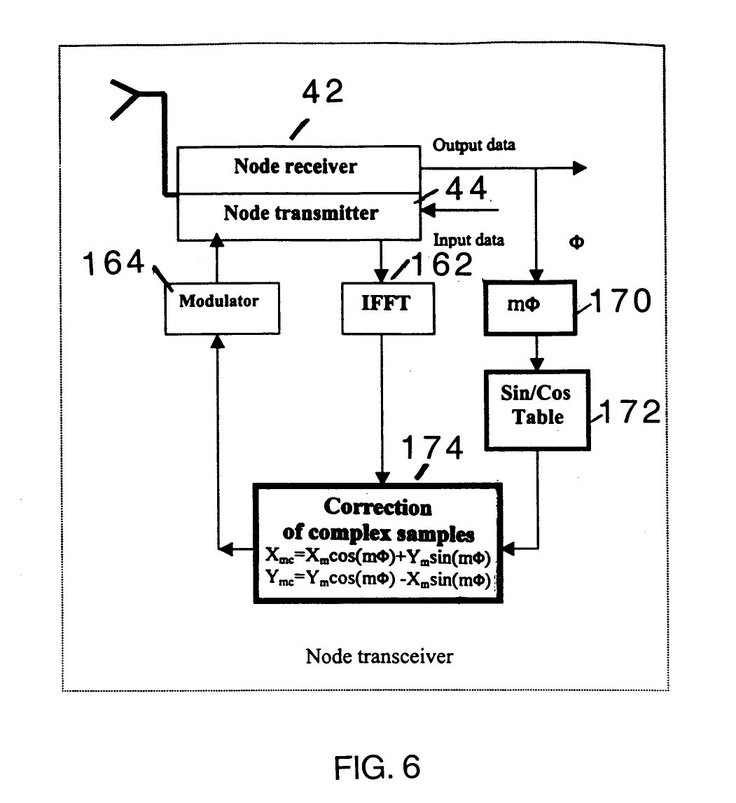

Correction of the samples at the IFFT output in the transmitter can be provided according to equation (1.1), but in this case Sₘ will be the m-th complex sample of the transmitted signal at the output of IFFT, and S_{mc} will be the m-th sample of the compensated (frequency unshifted) signal in the transmitter. A detailed description of the corresponding algorithm is provided below with reference to FIG. 6.

So, according to the invention, a method of frequency offset compensation in MPTP OFDM systems includes steps of: in the hub 20, estimating the frequency offset in the frequency domain (i.e., after FFT) for each group of carriers; transmitting the frequency offset parameters for each group of carriers from the hub 20 to the nodes 40; and in each node, accomplishing frequency offset compensation in the time domain (i.e., after IFFT). This method is implemented in the system 10 of FIG. 3 with the frequency domain estimation of frequency offsets for all carrier groups accomplished in the estimation block 28 of the hub 20, and the frequency offset compensation (i.e., correction of complex samples of the carrier groups) accomplished in the correction blocks 48 of the nodes 40.

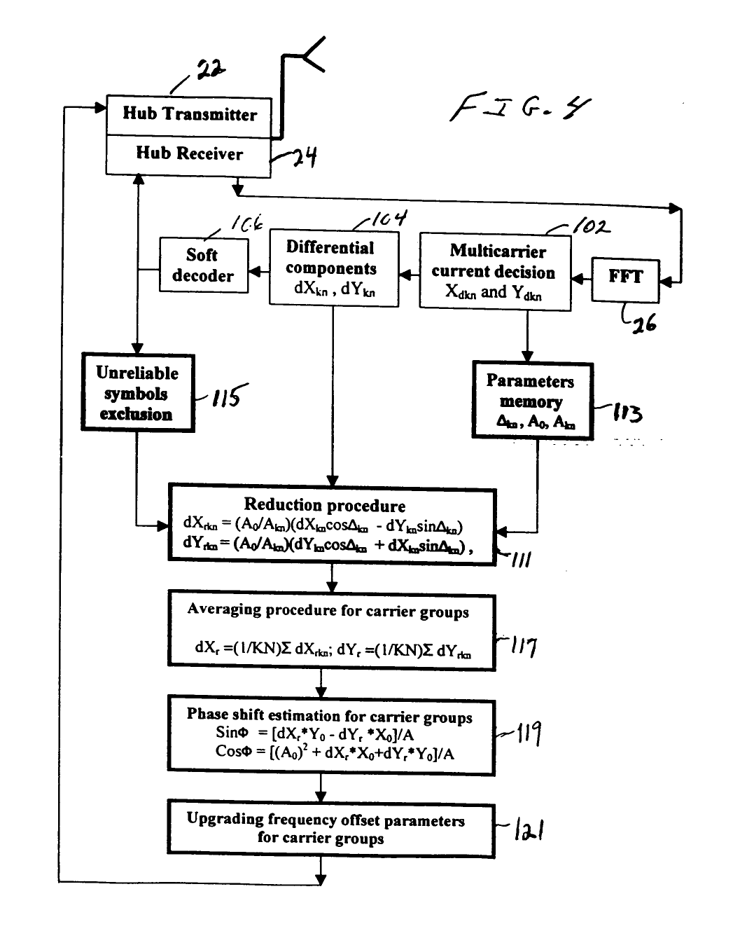

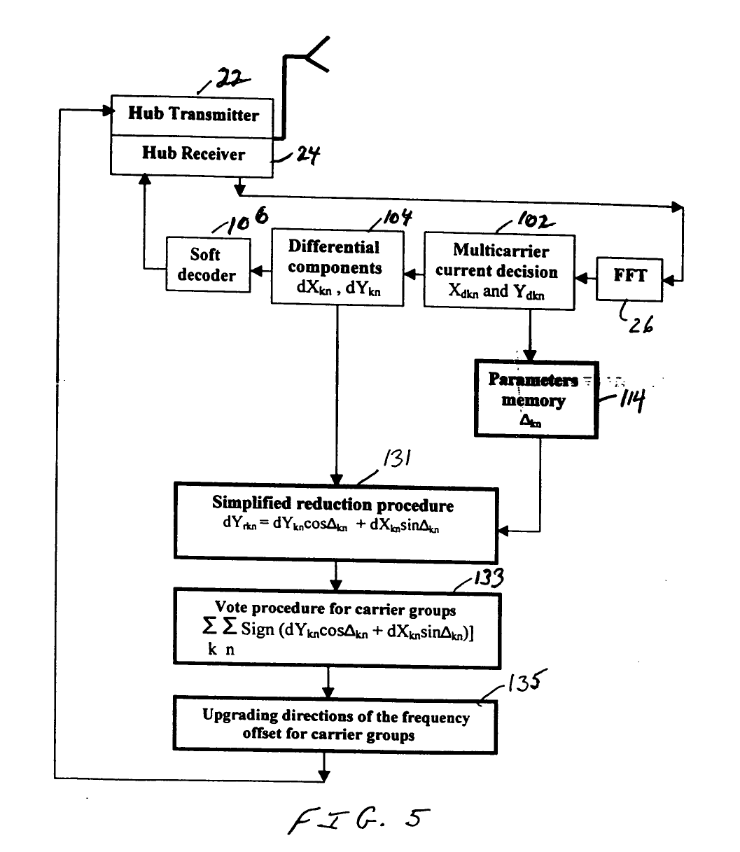

More particularly, during a telecommunication session between the hub 20 and the nodes 40, the hub 20 receiver 24 receives all transmitted carriers (as transmitted by the transmitters 44 of the nodes 40), and after their FFT transformation by FFT block 26, uses its estimation block 28 to provide a two-dimensional (in time and frequency domains) estimation of frequency offset parameters for all carrier groups (subsets of carriers) associated with different nodes participating in the session (as described in more detail hereinafter with reference to FIGS. 4 and 5). Then, the hub uses its transmitter 22 to transmit to all nodes 40 parameters of their frequency offsets as estimated. The nodes 40 receive the parameters via their receivers 42, and after inverse fast Fourier transform into the time domain via IFFT 46, each node compensates its frequency offset by means of the signal correction block 48 in the time domain.

It should be noted that during a current telecommunication session, each node 40 can also compensate its frequency offset in the frequency domain or in both frequency and time domains (as will be described hereinafter), but the correction blocks 48a, 48b of FIG. 3 shows only time domain correction after IFFT, which is the presently preferred embodiment of the invention from an implementation point of view.

As previously mentioned, according to the invention it is desirable to conduct a frequency offset estimation at the hub 20 for each carrier group utilized by different nodes 40 for data transmission to the hub 20. According to the preferred embodiment of the invention, the frequency offset estimation algorithms utilized are based on reducing and averaging quadrature components or differential quadrature components of the received carriers. Two different frequency offset estimation algorithms are shown in flow-chart format in FIGS. 4 and 5.

Before turning to FIG. 4, it is useful to provide the mathematical basis for the frequency offset estimation algorithms. In particular, if Xₖₙ and Yₖₙ are quadrature components of the received n-th symbol of the k-th carrier, then the differential components of the n-th symbol of the k-th carrier dXₖₙ and dYₖₙ are calculated as follows:
dXₖₙ=(Xₖₙ−Xd_{dkn}), (2.1a)
dYₖₙ=(Yₖₙ−Yd_{dkn}), (2.1b)
where X_{dkn}, Y_{dkn} are quadrature components of a decision for the n-th symbol of the k-th carrier, which typically corresponds to a constellation point nearest to the received vector (Xₖₙ,Yₖₙ)

Given the differential components of equations (2.1a) and (2.1b), the reduced differential components dXᵣₖₙ and dYᵣₖₙ of the n-th symbol of the k-th carrier are determined according to
dXᵣₖₙ=(A₀/Aₖₙ) (dXₖₙ cos Δₖₙ−dYₖₙ sin Δₖₙ), (2.2a)
dYᵣₖₙ=(A₀/Aₖₙ) (dYₖₙ cos Δₖₙ+dXₖₙ sin Δₖₙ), (2.2b)
where Δkn is the phase difference between the decision vector for the n-th symbol of the k-th carrier and the reference vector, Aₖₙ is the amplitude of the decision vector for the n-th symbol of the k-th carrier, and A₀ is the amplitude of the reference vector. It should be noted that, conceptually, any two-dimensional vector can be considered as the reference vector. In practice, however, some reference vectors may be more convenient than others. Two reference vectors in particular may have practical advantage: the first being a reference vector coinciding with one of the constellation points, and the second being a reference vector coinciding with X-axis or Y-axis in the two-dimensional space (e.g., vector (1,0) or (0,1)).

Just as the differential quadrature components of equations (2.1a) and (2.1b) can be reduced as in equations (2.2a) and (2.2b), quadrature components of the received carriers Xₖₙ and Yₖₙ may also be directly reduced to the corresponding components Xᵣₖₙ and Yᵣₖₙ of the reference vector:
Xᵣₖₙ=(A₀/Aₖₙ) (Xₖₙ cos Δₖₙ−Yₖₙ sin Δₖₙ), (2.2c)
Yᵣₖₙ=(A₀/Aₖₙ) (Yₖₙ cos Δₖₙ+Xₖₙ sin Δₖₙ), (2.2d)

The reduced differential components dXᵣₖₙ and dYᵣₖₙ as well as reduced quadrature components Xᵣₖₙ and Yᵣₖₙ may be averaged both in the time domain and in the frequency domain, i.e., through indexes n and k, correspondingly. If the considered group of carriers has a common frequency shift, then a result of averaging in time and frequency domains will be to detect this common frequency shift.

A general expression for the two-dimensional averaging of reduced differential components dXᵣₖₙ and dYᵣₖₙ within a group of K carriers on N symbol intervals for each carrier can be presented as follows:

$$\begin{matrix}\begin{matrix}{dX}_{r} = ( 1 / KN ) \sum {dX}_{rkn} \\ = ( {A}_{0} / KN ) {\sum }_{k = 1}^{K} {\sum }_{n = 1}^{N} ( {dX}_{kn} cos {Δ}_{kn} - {dY}_{kn} sin {Δ}_{kn} ) / {A}_{k}\end{matrix} & ( 2.3 a ) \\ \begin{matrix}{dY}_{r} = ( 1 / KN ) \sum {dY}_{rkn} \\ = ( {A}_{0} / KN ) {\sum }_{k = 1}^{K} {\sum }_{n = 1}^{N} ( {dY}_{kn} cos {Δ}_{kn} + {dX}_{kn} sin {Δ}_{kn} ) / {A}_{kn}\end{matrix} & ( 2.3 b )\end{matrix}$$

Likewise, the reduced quadrature components of the received carriers Xᵣₖₙ and Yᵣₖₙ from (2.2c) and (2.2d) may be averaged according to:

$$\begin{matrix}\begin{matrix}{X}_{r} = ( 1 / KN ) \sum {X}_{rkn} \\ = ( {A}_{0} / KN ) {\sum }_{k = 1}^{K} {\sum }_{n = 1}^{N} ( {X}_{kn} cos {Δ}_{kn} - {Y}_{kn} sin {Δ}_{kn} ) / {A}_{kn}\end{matrix} , & ( 2.3 c ) \\ \begin{matrix}{Y}_{r} = ( 1 / KN ) \sum {Y}_{rkn} \\ = ( {A}_{0} / KN ) {\sum }_{k = 1}^{K} {\sum }_{n = 1}^{N} ( {Y}_{kn} cos {Δ}_{kn} + {X}_{kn} sin {Δ}_{kn} ) / {A}_{kn}\end{matrix} , & ( 2.3 d )\end{matrix}$$

As will be appreciated by those skilled in the art, the averaging procedure of equations (2.3) involves components of K carriers and N symbols for each carrier. The values utilized for K and N preferably depend on the required number of averaged components necessary and sufficient for reliable estimates. For example, if R is the desired number of averaged components for a reliable estimate, then
R=KN. (2.4)

Simulations of OFDM systems in typical WLAN conditions show that R=50 is generally sufficient for a precise estimation of frequency offset. Thus, according to one preferred aspect of the invention,
KN≈50. (2.5)

Those skilled in the art will appreciate that the number N of averaged symbols thus depends on the size K of the carrier group. A first extreme case is where the carrier group contains sufficient numbers of carriers such that N can equal 1. In this case averaging can be completely provided in the frequency domain. A second extreme case is where a group contains a single carrier (i.e., K=1). In this case, averaging is completely provided in the time domain.

The estimates Xᵣ and Yᵣ from equations (2.3c) and (2.3d) are approximate coordinates of a new reference vector, shifted relative to the initial one because of frequency offset, and the estimates dXᵣ and dYᵣ from (2.3a) and (2.3b) are approximate coordinates of the difference between the shifted reference vector and the reference vector. These estimates (Xᵣ and Yᵣ or dXᵣ and dYᵣ) permit the expression of a phase shift caused by the frequency offset as a phase angle φ.

Taking into account that the shifted reference vector has coordinates X₀+dXᵣ and Y₀+dYᵣ, where X₀ and Y₀ are coordinates of the reference vector, trigonometric functions of the phase φ can be derived as follows:
Sin φ=[(X₀+dXᵣ)Y₀−(Y₀+dYᵣ)X₀]/A=[dXᵣY₀−dYᵣX₀]/A, (2.6a)
Cos φ=[(X₀+dXᵣ)X₀+(Y₀+dYᵣ)Y₀]/A=[(A₀)²+dXᵣX₀+dYᵣY₀]/A, (2.6b)
where A=A₀*[(X₀+dXᵣ)²+(Y₀+dYᵣ)²]^{0.5}. If, for example, the reference vector has coordinates X₀=1 and Y₀=0, then equations (2.6a) and (2.6b) reduce as follows:
Sin φ=−dYᵣ/A (2.6c)
Cos φ=(1+dXᵣ)/A (2.6d)

If the amplitude change of the reference vector (due to noise) is negligible, then equations (2.6c and (2.6d) further reduce according to
Sin φ≈−dYᵣ, (2.6e)
Cos φ≈1. (2.6f)

As will be appreciated by those skilled in the art, the trigonometric functions of phase φ can also be derived through estimates Xᵣ and Yᵣ from equations (2.3c) and (2.3d) as follows:
Sin φ=(XᵣY₀−YᵣX₀)/A, (2.7a)
Cos φ=(XᵣX₀+YᵣY₀)/A, (2.7b)
where A=A₀[(Xᵣ)²+(Yᵣ)²]^{0.5}. If, for example, the reference vector has coordinates Xₒ=1 and Y₀=0, then equations (2.7a) and (2.7b) reduce as follows:
Sin φ=−Yᵣ/A, (2.7c)
Cos φ=Xᵣ/A. (2.7d)

If the amplitude change of the reference vector (due to noise) is negligible, then equations (2.7c) and (2.7d) further reduce to
Sin φ≈−Yᵣ, (2.7e)
Cos φ≈1. (2.7f)

Estimates (2.6) and (2.7), which are the sine and cosine functions of the phase shift caused by the frequency offset, may be considered as the desired parameters of the frequency offset for the corresponding group of carriers. According to the invention, these parameters are transmitted from the hub 20 to the node 40 utilizing the corresponding group of carriers.

It should be appreciated that any other transformations of estimates (2.6) and (2.7) can be also used as the parameters of the frequency offset and be transmitted from the hub to the nodes. For example, functions Sin φ and Cos φ can be combined into one single number for transmission to the corresponding node:
φ=arctg(Sin φ/Cos φ). (2.8)

In turn, the phase parameter of equation (2.8) can be transformed into a frequency parameter and expressed in Hz:
Δf=φ/2πT (2.9)

Given the above, according to the invention, a preferred general algorithm for frequency offset estimation comprises (the algorithm being described in parallel for both differential quadrature components and quadrature components of the received signal):
1) After FFT in the hub receiver, a set of quadrature components Xₖₙ and Yₖₙ of the received carriers at the n-th symbol interval is used for making multicarrier current decisions X_{dkn} and Y_{dkn}, and differential quadrature components of the carriers dXₖₙ and dYₖₙ are calculated according to equation (2.1);
2) Using the current decisions, the set of differential quadrature components dXₖₙ, dYₖₙ or the set of quadrature components Xₖₙ, Yₖₙ is reduced according to equation (2.2) for all carriers;
3) Reduced differential quadrature components dXᵣₖₙ, dYᵣₖₙ or reduced quadrature components Xᵣₖₙ, Yᵣₖₙ are averaged within each group of carriers associated with different users in the frequency domain (K carriers of a group) and in the time domain (N symbols of each carrier) to find estimates of a differential reference vector dXᵣ, dYᵣ or a reference vector Xᵣ, Yᵣ for each carrier group according to equation (2.3);
4) Using estimates of the differential reference vector dXᵣ, dYᵣ or reference vector Xᵣ, Yᵣ, trigonometric functions of phase shifts for each carrier group are calculated according to equations (2.6) or (2.7); and
5) Upgraded parameters of frequency offsets for carrier groups according to equations (2.6), (2.7), (2.8), or (2.9) or their transformations, are transmitted by the hub transmitter to all nodes participating in the session.

The general algorithm for frequency offset estimation based on differential quadrature components of the received carriers is illustrated in FIG. 4, which shows a block and flow diagram of the hub 20 of the MPTP OFDM system 10. In FIG. 4, bold lined blocks carry out the frequency offset estimation algorithm, while the remaining blocks are a conventional part of the receiver. It should be noted that the FFT unit 26, the multicarrier decision unit 102, the differential components calculator 104, and the soft decoder 106 are shown apart from the hub receiver 24 so that their connections to the estimating procedure can be more easily seen, as their signals are partly used in the algorithm.

The conventional part of the hub receiver operates as follows. Digital samples of the n-th received multicarrier symbol are fed to the FFT unit 26. Complex numbers (Xₖₙ,Yₖₙ) for the whole set of carriers from the output of the FFT are fed to multicarrier decision unit 102 where current decisions (X_{dkn}, Y_{dkn}) for all carriers are made. Decisions (X_{dkn}, Y_{dkn}) are typically used for the calculation of differential quadrature components (dXₖₙ, dYₖₙ) of the received carriers by calculator 104 according to equation (2.1), which, in turn, are used in the soft decoder 106. Corrected symbols from the soft decoder are then fed to output circuits (not shown) of the hub receiver 24.

According to the invention, the differential quadrature components (dXₖₙ,dYₖₙ) calculated by differential components calculator 104 are reduced at 111 according to equations (2.2a) and (2.2b). The reduction procedure also utilizes parameters of signal reduction Δₖₙ, Δ₀, Aₖₙ or their combinations such as A₀/Aₖₙ stored in the parameters memory 113. Additionally, the reduction procedure can utilize exclusion of unreliable symbols from the further processing as described in previously incorporated U.S. Ser. No. 10/628,943. The exclusion signal (if applied) is provided by the unreliable symbols exclusion block 115 located between the soft decoder 106 and the reduction unit 111. The unreliable symbols exclusion block 115 utilizes information regarding symbol reliability from the soft decoder 106.

It should be noted that the reduction procedure 111 involves all carriers utilized in the system and does not depend on their combination in carrier groups. In contrast to the reduction procedure, the averaging procedure 117 is carried out separately for each carrier group participating in the session, according to equations (2.3a) and (2.3b). For each carrier group averaging can involve different numbers of carriers K and different numbers of symbols N. The averaging unit 117 provides estimates dXᵣ and dYᵣ (i.e., approximate coordinates of the difference between the shifted reference vector and the reference vector) for each carrier group. These estimates are then utilized by the phase shift estimation block 119 to generate functions of the phase φ according to equations (2.6) for each carrier group (e.g., Sin φ and Cos φ). These functions may then be modified in block 121 as in equations (2.8) or (2.9) to provide indications of the phase shift for each carrier group which are fed to the hub transmitter 22 to be transmitted to the nodes 40 as a hub instruction for current frequency correction.

As previously suggested, the general algorithm for frequency offset estimation as described with reference to FIG. 4 can be simplified. The simplification of frequency offset estimation algorithm for carrier groups is based on the fact that, if the reference vector is chosen carefully, the trigonometric functions of phase reduce and can be represented in other manners. For example, if the reference vector is chosen to be (1,0), then a sign of the Y-coordinates of the reduced differential vectors or corrected reference vectors coincides with a sign of the received vectors phase shift, and the phase shift is proportional to the absolute value of the Y-coordinates of the vectors. So, using equations (2.6e) and (2.7e),

$$\begin{matrix}\begin{matrix}Sin ϕ \approx - {dY}_{r} \\ = ( {A}_{0} / KN ) {\sum }_{k = 1}^{K} {\sum }_{n = 1}^{N} ( {dY}_{kn} cos {Δ}_{kn} + {dX}_{kn} sin {Δ}_{kn} ) / {A}_{kn}\end{matrix} . & ( 2.10 a ) \\ \begin{matrix}Sin ϕ \approx - {Y}_{r} \\ = ( {A}_{0} / KN ) {\sum }_{k = 1}^{K} {\sum }_{n = 1}^{N} ( {Y}_{kn} cos {Δ}_{kn} + {X}_{kn} sin {Δ}_{kn} ) / {A}_{kn}\end{matrix} , & ( 2.10 b )\end{matrix}$$

Sin φ values may then be directly utilized as desired parameters of frequency offset or they can be used as the basis for transformed parameters such as the transformed parameters set forth in equations (2.8) and (2.9).

Further simplification of frequency offsets estimation for carrier groups is based on majority vote approach where the accumulation of terms in equations (2.10a) or (2.10b) is replaced by an accumulation of their signs. The procedure includes two steps: simplified reduction of the received vectors for all carriers, and accumulation of signs of the reduced components for carrier groups.

The simplified reduction procedure includes only the Y-coordinate of the reduced vector and only one decision parameter Δₖₙ:
dYᵣₖₙ=(dYₖₙ cos Δₖₙ+dXₖₙ sin Δₖₙ), (2.11a)
Yᵣₖₙ=(Yₖₙ cos Δₖₙ+Xₖₙ sin Δₖₙ). (2.11b)

Signs of the reduced components (2.11a) or (2.11b) are then accumulated (majority votes) for each carrier group according to

$$\begin{matrix}{D}_{+ -} = {\sum }_{k = 1}^{K} {\sum }_{n = 1}^{N} Sign ( {dY}_{kn} cos {Δ}_{kn} + {dX}_{kn} sin {Δ}_{kn} ) , & ( 2.12 a ) \\ {D}_{+ -} = {\sum }_{k = 1}^{K} {\sum }_{n = 1}^{N} Sign ( {Y}_{kn} cos {Δ}_{kn} + {X}_{kn} sin {Δ}_{kn} ) , & ( 2.12 b )\end{matrix}$$

where Sign(x)=+1 or −1. The resulting integer D₊₋ is the difference between the number of components with positive phase shifts and a number of components with negative phase shifts. This integer reflects carrier majority vote, and its sign determines a direction for frequency offset adjustment.

The integer value obtained pursuant to equations (2.12a) and (2.12b) can serve as a parameter of frequency offset for the corresponding carrier group. In this case, the value should be transmitted to the node transmitter and utilized for offset compensation.

It should be noted that replacement of terms in equations (2.10) by their signs in equations (2.12) provides some mitigation of the effect of wrong decisions, because with the use of signs, wrong decisions cannot dramatically change the result. Additional robustness of equations (2.12) may be achieved by using a lower bound for majority votes. For example, if the modulo of D₊₋ is less than some predetermined threshold T_{d}, no corrections are provided. The threshold T_{d} may be chosen to depend on the number of components in equations (2.12), which is preferably equal to KN. According to a preferred aspect of the invention, a threshold equal to approximately 10% of all components participating in averaging is utilized and is believed to provide a desired robustness to the system.

Since integer D₊₋ from equations (2.12) determines only a direction of frequency offset adjustment, it is desirable also to obtain a value (size) of the adjustment. Different mechanisms for obtaining frequency offset compensation value are available. A first mechanism involves averaging projections of the component majority. In this mechanism, differential carrier projections or carrier projections are accumulated as in equations (2.10) only for components from the majority votes, and then the resulting value is divided by the number of majority components. For example, if the total number of components is equal to KN, then the number of majority components is equal to (KN+|D₊₋|)/2. In other words, in this mechanism the frequency offset is corrected by the projections corresponding to the largest number of occasions. It should be noted that the method has shown good results in the system simulation.

Another mechanism of determining the frequency offset value is based on an assumption that the frequency is slowly changing and can be efficiently corrected by changing the carrier frequency with a constant small increment. In this case the frequency offset estimation algorithm should determine only a direction of the adjustment. In turn, the adjustment direction Sign(φ) can be found as a sign of value D₊₋ from (2.12):

$$\begin{matrix}Sign ( ϕ ) = Sign [ {\sum }_{k = 1}^{K} {\sum }_{n = 1}^{N} Sign ( {dY}_{kn} cos {Δ}_{kn} + {dX}_{kn} sin {Δ}_{kn} ) ] , & ( 2.13 a ) \\ Sign ( ϕ ) = Sign [ {\sum }_{k = 1}^{K} {\sum }_{n = 1}^{N} Sign ( {Y}_{kn} cos {Δ}_{kn} + {X}_{kn} sin {Δ}_{kn} ) ] , & ( 2.13 b )\end{matrix}$$

It should be noted that the mechanism of changing the carrier frequency with a constant small increment is the simpler of the two mechanisms because it does not require a calculation of the frequency shift value. Its disadvantage, on the other hand, is that it cannot provide the precise proper constant increment for a wide range of frequency offset.

Based on the above, the simplified algorithm of frequency offset estimation can be described as follows (the algorithm is described in parallel for both differential quadrature components and quadrature components of the received signal):
1) After a FFT in the hub receiver, a set of quadrature components Xₖₙ and Yₖₙ of the received carriers at the n-th symbol interval is used for making multicarrier current decisions X_{dkn} and Y_{dkn}, and differential quadrature components of the carriers dXₖₙ and dYₖₙ are calculated according to equations (2.1);
2) Using the decisions, the set of differential quadrature components dXₖₙ, dYₖₙ or the set of quadrature components Xₖₙ, Yₖₙ is reduced according to equations (2.11) for all carriers;
3) Signs of the reduced differential quadrature components dYᵣₖₙ or reduced quadrature components Yᵣₖₙ are accumulated within each group of carriers associated with different users, in the frequency domain (K carriers of a group) and in time domain (N symbols of each carrier), and then transformed into an integer D₊₋ according to majority vote algorithm according to equations (2.12);
4) If D₊₋ is more than some predetermined threshold T_{d}, the direction of frequency correction is determined by the sign of D₊₋ according to equations (2.13), and the frequency offset value is determined to equal either the average offset of the majority components or a predetermined constant increment;
5) The upgraded parameters of frequency offsets for the carrier groups (i.e., the sign of the frequency adjustment and the frequency offset values for the carrier groups) are transmitted by the hub transmitter to all nodes participating in the session.

The simplified algorithm of frequency offset estimation is illustrated in the block and flow diagram of FIG. 5. As in FIG. 4, the bold lined blocks of FIG. 5 carry out the frequency offset estimation algorithm of the invention in the receiver of the hub 20, while the remaining units (the FFT 26, the multicarrier current decision unit 102, the differential components calculator 104, and the soft decoder 106) are part of a conventional hub receiver. Operation of this conventional part of the receiver was described above with reference to FIG. 4.

Operation of the frequency offset estimate blocks of FIG. 5 is as follows. Differential quadrature components (dXₖₙ, dYₖₙ) determined by block 104 are subjected to simplified reduction at 131 according to equations (2.11). The reduction procedure 131 utilizes parameters of signal reduction Δₖₙ stored in the parameters memory 114. It should be noted that the reduction procedure involves all of the carriers utilized in the system and is not dependent on their combination in groups. In contrast to the reduction procedure, the vote procedure at 133 according to equations (2.12) is carried out separately for each carrier group participating in the session. Calculation of a final sign at 135 according to equations (2.13) for each group can involve different numbers of carriers K and different numbers of symbols N. Finally, upgraded parameters of frequency offset are fed to the hub transmitter 22 to be transmitted to the nodes 40 as a hub instruction for current frequency correction.

As previously suggested, according to the invention, the frequency offset compensation information (i.e., the parameters) for the MPTP OFDM system is provided by the hub 20 to each node 40. Thus, during a current telecommunication session with the hub, each node compensates its frequency offset as indicated by the hub by means of a signal correction in the frequency and/or time domain.

There are different approaches to frequency correction in a radio transmitter. A traditional approach consists in the proper change of local oscillator frequency by Δf Hz determined via equation (2.9). In digital implementations of the OFDM algorithm, the preferable method for frequency correction is frequency offset compensation in the time domain after IFFT. This method can be described as follows. Let Xₘ and Yₘ be the real and imaginary parts of the m-th complex sample of a signal at the output of the IFFT in the node transmitter, where m is an integer changing from 1 to M, and M is the number of carriers in the multicarrier OFDM signal. Also assume that the signal is frequency shifted by Δf Hz. Then, taking into account equation (1.1), the real and imaginary parts X_{mc} and Y_{mc} of the m-th corrected sample are equal to
X_{mc}=Xₘ cos(mφ)+Yₘ sin(mφ), (3.1a)
Y_{mc}=Yₘ cos(mφ)−Xₘ sin(mφ), (3.1b)
where φ=2πΔfT, and T is an FFT interval.

It should be noted that in real computation algorithms, the product mφ in brackets of equations (3.1) is calculated modulo 2π. Further computation of cos(mφ) and sin(mφ) is typically provided by means of the stored table of sine and cosine functions within a 2π interval.

Implementation of equations (3.1) is illustrated in FIG. 6, which shows a detailed schematic diagram of the user-site (node) 40 of the MPTP OFDM system 10 of the invention, including the frequency offset compensation procedure in the time domain for the carrier group utilized by the node. In the block-diagram of FIG. 6, the bold lined units carry out the frequency offset compensation algorithm of the invention. The remaining units such as the IFFT 162 and the modulator 164 are conventional parts of the OFDM transmitter which are shown separately from the node transmitter 42 so that their connections to the compensation algorithm is more evident.

The frequency offset compensation algorithm is implemented using a phase multiplier “mφ” 170, a table of Sine and Cosine functions 172, and a correction of complex samples block 174. During the session with the hub 20, the node 40 receives a frequency-offset parameter for its carrier group. In FIG. 6 the parameter is shown as a phase shift φ=2πΔfT. This phase shift is modulo 2π multiplied at 170 by numbers m=1,2, . . . , M, where M is a total number of carriers in the system and m increases synchronously with the corresponding samples at the output of the IFFT 162. The multiplied phase mφ is fed to a Sine and Cosine functions table 172 which provides sine and cosine values to the correction block 174. Correction block 174 corrects the complex samples (Xₘ,Yₘ) generated by the IFFT according to equations (3.1). The corrected complex samples (X_{mc}, Y_{mc}) are fed to the transmitter modulator 164. With the provided corrections, the modulator 164 may then properly modulate all input data signals to be transmitted by the node transmitter 44 to the hub.

It should be noted that during a current telecommunication session with the hub 20, each node 40 can compensate its frequency offset in the frequency domain or in the time domain or in both the frequency and time domains. According to a preferred aspect of the invention, the initial frequency offset is roughly compensated in the frequency domain, while precise frequency offset tracking is provided in the time domain. More specifically, during a handshake between a hub and a node the hub receives a pilot signal from the node and roughly measures the frequency offset of this particular node transmitter. In the handshake period of time (before data transmission) the hub can assign a special set of carriers (group of carriers) for the node or the group of carriers may be predetermined for the node. In any case, during the handshake or preamble the hub transmits a frequency offset parameter to the node, and the node compensates using the indicated frequency shift in the frequency domain, for example, by changing the reference oscillator frequency. This provides a rough compensation of frequency offset. Then, during data transmission (the session), the precise compensation of the frequency offset is provided based on the previously described methods of the invention; i.e., the hub estimates the frequency offset for the carrier group, transmits frequency offset indications to the node, and the node compensates for the offset in the time domain.

According to another aspect of the invention, all of the previously described procedures for frequency offset compensation may be utilized in either a pure OFDMA mode or in a combined OFDMA/TDMA mode. In the pure (typical) OFDMA mode, the hub distributes all carriers or a subset of carriers among the nodes currently participating in a communication session, and all groups of carriers associated with different nodes are subjected to frequency offset compensation according to the proposed algorithms. In the combined OFDMA/TDMA mode, some group of carriers or part of a group (e.g., even a single carrier) can be assigned for utilization in two or more nodes. In this case, the nodes utilize the same carrier(s) within different time intervals according to a regular TDMA schedule indicated by the hub, or according to random channel access based, for example, on carrier sense multiple access (CSMA). In the combined OFDMA/TDMA mode, the frequency offset compensation procedure differs from the frequency offset compensation procedure of the pure OFDMA mode in substantially one only aspect: a subset of carriers utilized by two or more nodes is subjected to frequency offset compensation separately for each node associated with that subset of carriers. As a result, the hub must estimate frequency offsets not only for each group of carriers but also for each node utilizing the same group of carriers.

It will be appreciated by those skilled in the art that the flow charts of FIGS. 3-6 may be implemented in hardware, software, firmware, dedicated circuitry or programmable logic, digital signal processors, ASICS, or any combination of them.

There have been described and illustrated herein several embodiments of methods, systems and apparatus for pilotless frequency offset compensation in multipoint-to-point wireless systems with OFDM. While particular embodiments of the invention have been described, it is not intended that the invention be limited thereto, as it is intended that the invention be as broad in scope as the art will allow and that the specification be read likewise. Thus, while particular reference vectors have been disclosed as preferred, it will be appreciated that other reference vectors could be utilized as well. In addition, while particular frequency offset parameters were described as preferred for transfer from the hub to the nodes, it will be understood that other parameters (i.e., indications of frequency offset) could be provided. Also, while embodiments of the invention have been shown in the drawings in flow-chart format with particular function blocks, it will be recognized that the functionality of various of the blocks could be split or combined without affecting the overall approach of the invention. Further, while the invention was disclosed with reference to a soft decoder, it will be appreciated that a hard decoder could be utilized alone or in conjunction with the soft decoder, and that one or the other will suffice. It will therefore be appreciated by those skilled in the art that yet other modifications could be made to the provided invention without deviating from its spirit and scope as claimed.

1. An orthogonal frequency division multiplexing (OFDM) multipoint-to-point multicarrier wireless telecommunications system, comprising:
a hub including a hub receiver and a hub transmitter; and
a plurality of nodes each having a node receiver and a node transmitter, each said node transmitter for transmitting data over a unique group of carriers at the same time, wherein
said hub receiver is adapted to receive said data from each of said node transmitters and said hub is adapted to use said data to derive a frequency offset estimation for each node transmitter and to send an indication of each said frequency offset estimation to said nodes, and
said node receivers are adapted to receive said indication, and said node is adapted to modify data for transmission based at least partially on said indication.

2. A system according to claim 1, wherein:
said hub includes a fast Fourier transform (FFT) which converts data transmitted by said node transmitters over said carriers and received by said hub receiver into a frequency domain, and
said frequency offset estimation is conducted in said frequency domain.

3. A system according to claim 2, wherein:
said hub includes decision means coupled to said FFT for determining quadrature components X_{dkn} and Y_{dkn} of a decision vector from received vector outputs Xₖₙ, Yₖₙ of said FFT, where n is an index of OFDM symbols and k is an index of said carriers.

4. A system according to claim 3, wherein:
said hub includes means for calculating differential quadrature components dXₖₙ, dYₖₙ where dXₖₙ=(Xₖₙ−X_{dkn}) and dYₖₙ=(Yₖₙ−Y_{dkn}).

5. A system according to claim 4, wherein:
said hub includes means for reducing said differential quadrature components to obtain reduced differential components dXᵣₖₙ and dYᵣₖₙ according to
dXᵣₖₙ=(A₀/Aₖₙ) (dXₖₙ cos Δₖₙ−dYₖₙ sin Δₖₙ), and
dYᵣₖₙ=(A₀/Aₖₙ) (dYₖₙ cos Δₖₙ−dXₖₙ sin Δₖₙ),
where Δₖₙ is a phase difference between said decision vector for the n-th symbol of the k-th carrier and a reference vector, Aₖₙ is an amplitude of said decision vector for the n-th symbol of the k-th carrier, and A₀ is an amplitude of said reference vector.

6. A system according to claim 5, wherein:
said hub includes means for averaging reduced differential components by carrier group according to obtain group averages dXᵣ and dYᵣ according to
$$\begin{matrix}{dX}_{r} = ( 1 / KN ) \sum {dX}_{rkn} \\ = ( {A}_{0} / KN ) {\sum }_{k = 1}^{K} {\sum }_{n = 1}^{N} ( {dX}_{kn } cos {Δ}_{kn} - {dY}_{kn} sin {Δ}_{kn} ) / {A}_{k}\end{matrix}$$
$$\begin{matrix}{dY}_{r} = ( 1 / KN ) \sum {dY}_{rkn} \\ = ( {A}_{0} / KN ) {\sum }_{k = 1}^{K} {\sum }_{n = 1}^{N} ( {dY}_{kn } cos {Δ}_{kn} + {dX}_{kn} sin {Δ}_{kn} ) / {A}_{kn}\end{matrix}$$
where K is the number of carriers in a respective carrier group, and N is the number of symbols over which averaging is done.

7. A system according to claim 6, wherein:
N is chosen such that KN is a desired value.

8. A system according to claim 7, wherein:
KN is chosen to be at least 50.

9. A system according to claim 6, wherein:
said hub includes means for generating an indication of frequency offset for each carrier group based on said group average for said respective carrier group.

10. A system according to claim 9, wherein:
said means for generating an indication includes means for estimating phase shift for each carrier group according to
Sin φ=[dXᵣY₀−dYᵣX₀]/A, and Cos φ=[(A₀)²+dXᵣX₀+dYᵣY₀]/A
where φ is said phase shift, and A=A₀*[(X₀+dXᵣ)²+(Y₀+dYᵣ)²]^{0.5} where X₀ and Y₀ are coordinates of said reference vector.

11. A system according to claim 10, wherein:
said reference vector is chosen such that X₀=1 and Y₀=0.

12. A system according to claim 10, wherein:
said indication is a function of Sin φ and Cos φ.

13. A system according to claim 12, wherein:
said indication is one of φ and Δf where Δf=φ/2πT.

14. A system according to claim 3, wherein:
said hub includes means for reducing said quadrature components to obtain reduced quadrature components dXᵣₖₙ and dYᵣₖₙ according to
Xᵣₖₙ=(A₀/Aₖₙ) (Xₖₙ cos Δₖₙ−Yₖₙ sin Δₖₙ),
Yᵣₖₙ=(A₀/Aₖₙ) (Yₖₙ cos Δₖₙ−Xₖₙ sin Δₖₙ)
where Δₖₙ is a phase difference between said decision vector for the n-th symbol of the k-th carrier and a reference vector, Aₖₙ is an amplitude of said decision vector for the n-th symbol of the k-th carrier, and A₀ is an amplitude of said reference vector.

15. A system according to claim 14, wherein:
said hub includes means for averaging reduced quadrature components by carrier group according to obtain group averages dXᵣ and dYᵣ according to
$$\begin{matrix}{X}_{r} = ( 1 / KN ) \sum {X}_{rkn} \\ = ( {A}_{0} / KN ) {\sum }_{k = 1}^{K} {\sum }_{n = 1}^{N} ( {X}_{kn } cos {Δ}_{kn} - {Y}_{kn} sin {Δ}_{kn} ) / {A}_{k}\end{matrix}$$
$$\begin{matrix}{Y}_{r} = ( 1 / KN ) \sum {Y}_{rkn} \\ = ( {A}_{0} / KN ) {\sum }_{k = 1}^{K} {\sum }_{n = 1}^{N} ( {Y}_{kn } cos {Δ}_{kn} + {X}_{kn} sin {Δ}_{kn} ) / {A}_{kn}\end{matrix}$$
where K is the number of carriers in a respective carrier group, and N is the number of symbols over which averaging is done.

16. A system according to claim 15, wherein:
N is chosen such that KN is a desired value.

17. A system according to claim 16, wherein:
KN is chosen to be at least 50.

18. A system according to claim 15, wherein:
said hub includes means for generating an indication of frequency offset for each carrier group based on said group average for said respective carrier group.

19. A system according to claim 18, wherein:
said means for generating an indication includes means for estimating phase shift for each carrier group according to
Sin φ=[XᵣY₀−YᵣX₀]/A, and Cos φ=[XᵣX₀+YᵣY₀]/A
where φ is said phase shift, and A=A₀*[(Xᵣ)²+(Yᵣ)²]^{0.5} where X₀ and Y₀ are coordinates of said reference vector.

20. A system according to claim 19, wherein:
said reference vector is chosen such that X₀=1 and Y₀=0.

21. A system according to claim 4, wherein:
said hub includes means for reducing said differential quadrature components to obtain reduced differential components dYᵣₖₙ according to dYᵣₖₙ=(dYₖₙ cos Δₖₙ+dXₖₙ sin Δₖₙ), where Δₖₙ is a phase difference between said decision vector for the n-th symbol of the k-th carrier and a reference vector.

22. A system according to claim 21, wherein:
said hub includes means for accumulating signs of the reduced components for each said carrier group.

23. A system according to claim 22, wherein:
said means for accumulating signs accumulates said signs according to
$${D}_{+ -} = {\sum }_{k = 1}^{K} {\sum }_{n = 1}^{N} Sign ( {dY}_{kn} cos {Δ}_{kn} + {dX}_{kn} sin {Δ }_{kn} ) ,$$
Sign (dYₖₙ cos Δₖₙ+dXₖₙ sin Δₖₙ), where K is the number of carriers in a respective carrier group, N is the number of symbols over which averaging is done, Sign(x)=+1 or −1, and D₊₋ represents a difference between a number of components with positive phase shifts and a number of components with negative phase shifts in a carrier group and its sign determines a direction for frequency offset adjustment.

24. A system according to claim 23, wherein:
N is chosen such that KN is a desired value.

25. A system according to claim 24, wherein:
KN is chosen to be at least 50.

26. A system according to claim 23, wherein:
said hub further includes means for comparing said D₊₋ to a predetermined threshold value T_{d}.

27. A system according to claim 26, wherein:
said hub includes means for determining a frequency offset value for each carrier group as a function of an average offset of the majority components of that carrier group.

28. A system according to claim 26, wherein:
said hub includes means for determining an adjustment direction Sign(φ) according to
$$Sign ( ϕ ) = Sign [ {\sum }_{k = 1}^{K} {\sum }_{n = 1}^{N} Sign ( {dY}_{kn} cos {Δ}_{kn} + {dX}_{kn} sin {Δ }_{kn} ) ] .$$
Sign (dYₖₙ cos Δₖₙ+dXₖₙ sin Δₖₙ)].

29. A system according to claim 3, wherein:
said hub includes means for reducing said quadrature components to obtain reduced quadrature components Yᵣₖₙ according to Yᵣₖₙ=(Yₖₙ cos Δₖₙ+Xₖₙ sin Δₖₙ), where Δₖₙ is a phase difference between said decision vector for the n-th symbol of the k-th carrier and a reference vector.

30. A system according to claim 29, wherein:
said hub includes means for accumulating signs of the reduced components for each said carrier group.

31. A system according to claim 30, wherein:
said means for accumulating signs accumulates said signs according to
$${D}_{+ -} = {\sum }_{k = 1}^{K} {\sum }_{n = 1}^{N} Sign ( {Y}_{kn} cos {Δ}_{kn} + {X}_{kn} sin {Δ }_{kn} ) ,$$
Sign (Yₖₙ cos Δₖₙ+Xₖₙ sin Δₖₙ) , where K is the number of carriers in a respective carrier group, N is the number of symbols over which averaging is done, Sign(x)=+1 or −1, and D₊₋ represents a difference between a number of components with positive phase shifts and a number of components with negative phase shifts in a carrier group and its sign determines a direction for frequency offset adjustment.

32. A system according to claim 31, wherein:
N is chosen such that KN is a desired value.

33. A system according to claim 32, wherein:
KN is chosen to be at least 50.

34. A system according to claim 29, wherein:
said hub further includes means for comparing said D₊₋ to a predetermined threshold value T_{d}.

35. A system according to claim 34, wherein:
said hub includes means for determining a frequency offset value for each carrier group as a function of an average offset of the majority components of that carrier group.

36. A system according to claim 34, wherein:
said hub includes means for determining an adjustment direction Sign(φ) according to
$$Sign ( ϕ ) = Sign [ {\sum }_{k = 1}^{K} {\sum }_{n = 1}^{N} Sign ( {dY}_{kn} cos {Δ}_{kn} + {dX}_{kn} sin {Δ }_{kn} ) ] .$$

37. A system according to claim 1, wherein:
a first of said plurality of nodes utilizes a group of carriers including a first plurality of carriers and a second of said plurality of nodes utilizes a group of carrier including a second plurality of carriers different than said first plurality of carriers.

38. A system according to claim 1, wherein:
a first of said plurality of nodes utilizes a group of carriers including a single carrier and a second of said plurality of nodes utilizes a group of carrier including a plurality of carriers different than said single carrier.

39. A system according to claim 1, wherein:
each said node includes an inverse fast Fourier transformer (IFFT) and a signal correction means coupled to said IFFT for frequency offset compensation of data signals applied to and processed by said IFFT.

40. A system according to claim 39, wherein:
said signal correction means corrects a data signal according to X_{mc}=Xₘ cos(mφ)+Yₘ sin(mφ), Y_{mc}=Yₘ cos(mφ)−Xₘ sin(mφ), where Xₘ and Yₘ are respectively real and imaginary parts of an m-th complex sample of said signal at an output of said IFFT after processing by said IFFT, where m is an integer changing from 1 to M, and M is the number of carriers in said multicarrier system, X_{mc} and Y_{mc} are respectively real and imaginary parts of the m-th corrected sample, and φ is a function of said indication of said frequency offset estimation sent by said hub to said node.

41. A system according to claim 40, wherein:
each said node includes means for calculating a product mφ and a table which provides cos(mφ) and sin(mφ) values to said signal correction means in response to said means for calculating a product mφ.

42. A system according to claim 40, wherein:
said indication of said frequency offset estimation sent by said hub to said node is one of phase φ and a function of a change in frequency Δf where φ=2πΔfT and where T is an FFT interval.

43. A system according to claim 1, wherein:
said OFDM system is a time division multiplexed system where at least two of said plurality of nodes transmit on at least one same carrier for transmission but at different times.

44. A hub for an orthogonal frequency division multiplexing (OFDM) multipoint-to-point multicarrier wireless telecommunications system, comprising:
a hub receiver for receiving data from a plurality of nodes with each node sending said data over a unique group of carriers at the same time, and
a hub transmitter for sending a separate frequency offset estimation for each node, wherein
said hub includes means for utilizing said data to derive each said separate frequency offset estimation.

45. A hub according to claim 44, wherein:
said hub includes a fast Fourier transform (FFT) which converts said data into a frequency domain, and
said means for utilizing said data conducts a frequency offset estimation in said frequency domain.

46. A hub according to claim 45, wherein:
said means for utilizing said data includes decision means coupled to said FFT for determining quadrature components X_{dkn} and Y_{dkn} of a decision vector from received vector outputs Xₖₙ, Yₖₙ of said FFT, where n is an index of OFDM symbols and k is an index of said carriers.

47. A hub according to claim 46, wherein:
said means for utilizing said data includes means for calculating differential quadrature components dXₖₙ, dYₖₙ where dXₖₙ=(Xₖₙ−Xdₖₙ) and dYₖₙ=(Yₖₙ−Y_{dkn}).

48. A hub according to claim 47, wherein:
said means for utilizing said data includes means for reducing said differential quadrature components to obtain reduced differential components dXᵣₖₙ and dYᵣₖₙ according to
dXᵣₖₙ=(A₀/Aₖₙ) (dXₖₙ cos Δₖₙ−dYₖₙ sin Δₖₙ), and
dYᵣₖₙ=(A₀/Aₖₙ) (dYₖₙ cos Δₖₙ−dXₖₙ sin Δₖₙ),
where Δₖₙ is a phase difference between said decision vector for the n-th symbol of the k-th carrier and a reference vector, Δₖₙ is an amplitude of said decision vector for the n-th symbol of the k-th carrier, and A₀ is an amplitude of said reference vector.

49. A hub according to claim 48, wherein:
said means for utilizing said data includes means for averaging reduced differential components by carrier group according to obtain group averages dXᵣ and dYᵣ according to
$$\begin{matrix}{dX}_{r} = ( 1 / KN ) \sum {dX}_{rkn} \\ = ( {A}_{0} / KN ) {\sum }_{k = 1}^{K} {\sum }_{n = 1}^{N} ( {dX}_{kn } cos {Δ}_{kn} - {dY}_{kn} sin {Δ}_{kn} ) / {A}_{k}\end{matrix}$$
$$\begin{matrix}{dY}_{r} = ( 1 / KN ) \sum {dY}_{rkn} \\ = ( {A}_{0} / KN ) {\sum }_{k = 1}^{K} {\sum }_{n = 1}^{N} ( {dY}_{kn } cos {Δ}_{kn} + {dX}_{kn} sin {Δ}_{kn} ) / {A}_{kn}\end{matrix}$$
where K is the number of carriers in a respective carrier group, and N is the number of symbols over which averaging is done.

50. A hub according to claim 49, wherein:
N is chosen such that KN is a desired value.

51. A hub according to claim 50, wherein:
KN is chosen to be at least 50.

52. A hub according to claim 49, wherein:
said means for utilizing said data includes means for generating an indication of frequency offset for each carrier group based on said group average for said respective carrier group.

53. A hub according to claim 52, wherein:
said means for generating an indication includes means for estimating phase shift for each carrier group according to
Sin φ=[dXᵣY₀−dYᵣX₀]/A, and Cos φ=[(A₀)²+dXᵣX₀+dYᵣY₀]/A
where φ is said phase shift, and A=A₀*[(X₀+dXᵣ)²+(Y₀+dYᵣ)²]^{0.5} where X₀ and Y₀ are coordinates of said reference vector.

54. A hub according to claim 53, wherein:
said reference vector is chosen such that X₀=1 and Y₀=0.

55. A hub according to claim 54, wherein:
said indication is a function of Sin φ and Cos φ.

56. A hub according to claim 5, wherein:
said indication is one of φ and Δf where Δf=φ/2πT.

57. A hub according to claim 46, wherein:
said means for utilizing said data includes means for reducing said quadrature components to obtain reduced quadrature components dXᵣₖₙ and dYᵣₖₙ according to Xᵣₖₙ=(A₀/Aₖₙ) (Xₖₙ cos Aₖₙ−Yₖₙ sin Δₖₙ), Yᵣₖₙ=(A₀/Aₖₙ) (Yₖₙ cos Δₖₙ+Xₖₙ sin Aₖₙ), where Δₖₙ is a phase difference between said decision vector for the n-th symbol of the k-th carrier and a reference vector, Aₖₙ is an amplitude of said decision vector for the n-th symbol of the k-th carrier, and A₀ is an amplitude of said reference vector.

58. A hub according to claim 57, wherein:
said means for utilizing said data includes means for averaging reduced quadrature components by carrier group according to obtain group averages dXᵣ and dYᵣ according to
$$\begin{matrix}{X}_{r} = ( 1 / KN ) \sum {X}_{rkn} \\ = ( {A}_{0} / KN ) {\sum }_{k = 1}^{K} {\sum }_{n = 1}^{N} ( {X}_{kn } cos {Δ}_{kn} - {Y}_{kn} sin {Δ}_{kn} ) / {A}_{k}\end{matrix}$$
$$\begin{matrix}{Y}_{r} = ( 1 / KN ) \sum {Y}_{rkn} \\ = ( {A}_{0} / KN ) {\sum }_{k = 1}^{K} {\sum }_{n = 1}^{N} ( {Y}_{kn } cos {Δ}_{kn} + {X}_{kn} sin {Δ}_{kn} ) / {A}_{kn}\end{matrix}$$
where K is the number of carriers in a respective carrier group, and N is the number of symbols over which averaging is done.

59. A hub according to claim 58, wherein:
N is chosen such that KN is a desired value.

60. A hub according to claim 59, wherein:
KN is chosen to be at least 50.

61. A hub according to claim 58, wherein:
said means for utilizing said data includes means for generating an indication of frequency offset for each carrier group based on said group average for said respective carrier group.

62. A hub according to claim 61, wherein:
said means for generating an indication includes means for estimating phase shift for each carrier group according to
Sin φ=[XᵣY₀−YᵣX₀]/A, and Cos φ[XᵣX₀+YᵣY₀]/A
where φ is said phase shift, and A=A₀*[(Xᵣ)²+(Yᵣ)²]^{0.5} where X₀ and Y₀ are coordinates of said reference vector.

63. A hub according to claim 62, wherein:
said reference vector is chosen such that X₀=1 and Y₀=0.

64. A hub according to claim 47, wherein:
said means for utilizing said data includes means for reducing said differential quadrature components to obtain reduced differential components dYᵣₖₙ according to dYᵣₖₙ=(dYₖₙ cos Δₖₙ+dXₖₙ sin Δₖₙ), where Δₖₙ is a phase difference between said decision vector for the n-th symbol of the k-th carrier and a reference vector.

65. A hub according to claim 64, wherein:
said means for utilizing said data includes means for accumulating signs of the reduced components for each said carrier group.

66. A hub according to claim 65, wherein:
said means for accumulating signs accumulates said signs according to
$${D}_{+ -} = {\sum }_{k = 1}^{K} {\sum }_{n = 1}^{N} Sign ( {dY}_{kn} cos {Δ}_{kn} + {dX}_{kn} sin {Δ }_{kn} ) ,$$
where K is the number of carriers in a respective carrier group, N is the number of symbols over which averaging is done, Sign(x)=+1 or −1, and D₊₋ represents a difference between a number of components with positive phase shifts and a number of components with negative phase shifts in a carrier group and its sign determines a direction for frequency offset adjustment.

67. A hub according to claim 66, wherein:
N is chosen such that KN is a desired value.

69. A hub according to claim 67, wherein:
KN is chosen to be at least 50.

69. A hub according to claim 68, wherein:
said means for utilizing said data further includes means for comparing said D₊₋ to a predetermined threshold value T_{d}.

70. A hub according to claim 69, wherein:
said means for utilizing said data includes means for determining a frequency offset value for each carrier group as a function of an average offset of the majority components of that carrier group.

71. A hub according to claim 69, wherein:
said means for utilizing said data includes means for determining an adjustment direction Sign(φ) according to
$$Sign ( ϕ ) = Sign [ {\sum }_{k = 1}^{K} {\sum }_{n = 1}^{N} Sign ( {dY}_{kn} cos {Δ}_{kn} + {dX}_{kn} sin {Δ }_{kn} ) ] .$$

72. A hub according to claim 46, wherein:
said means for utilizing said data includes means for reducing said quadrature components to obtain reduced quadrature components Yᵣₖₙ according to Yᵣₖₙ=(Yₖₙ cos Δₖₙ+Xₖₙ sin Δₖₙ), where Δₖₙ is a phase difference between said decision vector for the n-th symbol of the k-th carrier and a reference vector.

73. A hub according to claim 72, wherein:
said means for utilizing said data includes means for accumulating signs of the reduced components for each said carrier group.

74. A hub according to claim 73, wherein:
said means for accumulating signs accumulates said signs according to
$${D}_{+ -} = {\sum }_{k = 1}^{K} {\sum }_{n = 1}^{N} Sign ( {Y}_{kn} cos {Δ}_{kn} + {X}_{kn} sin {Δ }_{kn} ) ,$$
where K is the number of carriers in a respective carrier group, N is the number of symbols over which averaging is done, Sign(x)=+1 or −1, and D₊₋ represents a difference between a number of components with positive phase shifts and a number of components with negative phase shifts in a carrier group and its sign determines a direction for frequency offset adjustment.

75. A hub according to claim 74, wherein:
N is chosen such that KN is a desired value.

76. A hub according to claim 75, wherein:
KN is chosen to be at least 50.

77. A hub according to claim 72, wherein:
said means for utilizing said data further includes means for comparing said D₊₋ to a predetermined threshold value T_{d}.

78. A hub according to claim 77, wherein:
said means for utilizing said data includes means for determining a frequency offset value for each carrier group as a function of an average offset of the majority components of that carrier group.

79. A hub according to claim 77, wherein:
said means for utilizing said data includes means for determining an adjustment direction Sign(φ) according to
$$Sign ( ϕ ) = Sign [ {\sum }_{k = 1}^{K} {\sum }_{n = 1}^{N} Sign ( {dY}_{kn} cos {Δ}_{kn} + {dX}_{kn} sin {Δ }_{kn} ) ] .$$

80. A hub according to claim 44, wherein:
said hub receiver receives data from at least two nodes which utilize at least one same carrier at different times, wherein said means for utilizing said data derives a separate frequency offset estimation for each of said at least two nodes which utilize at least one same carrier at different times, and
said hub transmitter sends separate frequency offset estimation for said at least two nodes which utilize at least one same carrier at different times.

81. A node for an orthogonal frequency division multiplexing (OFDM) multipoint-to-point multicarrier wireless telecommunications system having a hub and a plurality of other nodes, the node comprising:
a node receiver which receives a function of an indication of a frequency offset estimation from the hub, the hub having generated the indication of a frequency offset estimation for said node receiver as a function of data receiver from said node and from the plurality of other nodes; and
a node transmitter for transmitting modulated corrected signals over at least one carrier, said node transmitter having an inverse fast Fourier transformer (IFFT), a signal correction means coupled to said IFFT for frequency offset compensation of data signals applied to and processed by said IFFT, and a modulator coupled to said signal correction means for modulating signals corrected by said signal correction means.

82. A node according to claim 81, wherein:
said signal correction means corrects a data signal according to X_{mc}=Xₘ cos(mφ)+Yₘ sin(mφ), Y_{mc}=Yₘ cos(mφ)−Xₘ sin(mφ), where Xₘ and Yₘ are respectively real and imaginary parts of an m-th complex sample of said signal at an output of said IFFT after processing by said IFFT, where m is an integer changing from 1 to M, and M is the number of carriers in the multicarrier system, X_{mc} and Y_{mc} are respectively real and imaginary parts of the m-th corrected sample, and φ is said function of said indication of said frequency offset estimation sent by the hub to said node.

83. A node according to claim 82, wherein:
said node transmitter includes means for calculating a product mφ and a table which provides cos(mφ) and sin(mφ) values to said signal correction means in response to said means for calculating a product mφ.

84. A node according to claim 81, wherein:
said indication of said frequency offset estimation sent by the hub to said node is one of phase φ and a function of a change in frequency Δf where φ=2πΔfT and where T is a time interval.

85. A method for implementing frequency offset compensation in an orthogonal frequency division multiplexing (OFDM) multipoint-to-point multicarrier wireless telecommunications system having a hub and a plurality of nodes, where each respective node transmits data over a unique group of carriers at the same time as the other nodes, said method comprising:
a) in the hub, estimating frequency offset in the frequency domain for each group of carriers;
b) transmitting frequency offset parameters for each group of carriers from the hub to the nodes; and
c) in each node transmitter using said frequency offset parameters to implement frequency offset compensation in the time domain.

86. A method according to claim 85, wherein:
said estimating frequency offset comprises utilizing a fast Fourier transform (FFT) to convert data transmitted by the node transmitters over the carriers and received by the hub into a frequency domain, and conducting said estimating in the frequency domain.

87. A method according to claim 86, wherein:
said estimating comprises determining quadrature components X_{dkn} and Y_{dkn} of a decision vector from received vector outputs Xₖₙ, Yₖₙ of the FFT, where n is an index of OFDM symbols and k is an index of the carriers.

88. A method according to claim 87, wherein:
said estimating further comprises calculating differential quadrature components dXₖₙ, dYₖₙ where dXₖₙ=(Xₖₙ−X_{dkn}) and dYₖₙ=(Yₖₙ−Y_{dkn}).

89. A method according to claim 88, wherein:
said estimating further comprises reducing said differential quadrature components to obtain reduced differential components dXᵣₖₙ and dYᵣₖₙ according to
dXᵣₖₙ=(A₀/Aₖₙ) (dXₖₙ cos Δₖₙ−dYₖₙ sin Δₖₙ), and
dYᵣₖₙ=(A₀/Aₖₙ) (dYₖₙ cos Δₖₙ−dXₖₙ sin Δₖₙ),
where Δₖₙ is a phase difference between said decision vector for the n-th symbol of the k-th carrier and a reference vector, Aₖₙ is an amplitude of said decision vector for the n-th symbol of the k-th carrier, and A₀ is an amplitude of said reference vector.

90. A method according to claim 89, wherein:
said estimating further comprises averaging reduced differential components by carrier group according to obtain group averages dXᵣ and dYᵣ according to
$$\begin{matrix}{dX}_{r} = ( 1 / KN ) \sum {dX}_{rkn} \\ = ( {A}_{0} / KN ) {\sum }_{k = 1}^{K} {\sum }_{n = 1}^{N} ( {dX}_{kn } cos {Δ}_{kn} - {dY}_{kn} sin {Δ}_{kn} ) / {A}_{k}\end{matrix}$$
$$\begin{matrix}{dY}_{r} = ( 1 / KN ) \sum {dY}_{rkn} \\ = ( {A}_{0} / KN ) {\sum }_{k = 1}^{K} {\sum }_{n = 1}^{N} ( {dY}_{kn } cos {Δ}_{kn} + {dX}_{kn} sin {Δ}_{kn} ) / {A}_{kn}\end{matrix}$$
where K is the number of carriers in a respective carrier group, and N is the number of symbols over which averaging is done.

91. A method according to claim 90, wherein:
N is chosen such that KN is a desired value.

92. A method according to claim 91, wherein:
KN is chosen to be at least 50.

93. A method according to claim 90, wherein:
said estimation includes generating an indication of frequency offset for each carrier group based on said group average for said respective carrier group.

94. A method according to claim 93, wherein:
said generating an indication includes means for estimating phase shift for each carrier group according to
Sin φ=[dXᵣY₀−dYᵣX₀]/A, and Cos φ=[(A₀)²+dXᵣX₀+dYᵣY₀]/A
where φ is said phase shift, and A=A₀*[(X₀+dXᵣ)²+(Y₀+dYᵣ)²]^{0.5} where X₀ and Y₀ are coordinates of said reference vector.

95. A method according to claim 94, wherein:
said reference vector is chosen such that X₀=1 and Y₀=0.

96. A method according to claim 94, wherein:
said indication is a function of Sin φ and Cos φ.

97. A method according to claim 86, wherein:
said indication is one of φ and Δf where Δf=φ/2πT.

98. A method according to claim 87, wherein:
said estimating further comprises reducing said quadrature components to obtain reduced quadrature components dXᵣₖₙ and dYᵣₖₙ according to Xᵣₖₙ=(A₀/Aₖₙ) (Xₖₙ cos Δₖₙ−Yₖₙ sin Δₖₙ),
Yᵣₖₙ=(A₀/Aₖₙ) (Yₖₙ cos Δₖₙ+Xₖₙ sin Δₖₙ)
where Δₖₙ is a phase difference between said decision vector for the n-th symbol of the k-th carrier and a reference vector, Aₖₙ is an amplitude of said decision vector for the n-th symbol of the k-th carrier, and A₀ is an amplitude of said reference vector.

99. A method according to claim 98, wherein:
said estimating further comprises averaging reduced quadrature components by carrier group according to obtain group averages dXᵣ and dYᵣ according to
$$\begin{matrix}{X}_{r} = ( 1 / KN ) \sum {X}_{rkn} \\ = ( {A}_{0} / KN ) {\sum }_{k = 1}^{K} {\sum }_{n = 1}^{N} ( {X}_{kn } cos {Δ}_{kn} - {Y}_{kn} sin {Δ}_{kn} ) / {A}_{k}\end{matrix}$$
$$\begin{matrix}{Y}_{r} = ( 1 / KN ) \sum {Y}_{rkn} \\ = ( {A}_{0} / KN ) {\sum }_{k = 1}^{K} {\sum }_{n = 1}^{N} ( {Y}_{kn } cos {Δ}_{kn} + {X}_{kn} sin {Δ}_{kn} ) / {A}_{kn}\end{matrix}$$
where K is the number of carriers in a respective carrier group, and N is the number of symbols over which averaging is done.

100. A method according to claim 99, wherein:
N is chosen such that KN is a desired value.

101. A method according to claim 100, wherein:
KN is chosen to be at least 50.

102. A method according to claim 99, wherein:
said estimating further comprises generating an indication of frequency offset for each carrier group based on said group average for said respective carrier group.

103. A method according to claim 102, wherein:
said generating an indication includes estimating phase shift for each carrier group according to Sin φ=[XᵣY₀−YᵣX₀]/A, and Cos φ=[XᵣX₀+YᵣY₀]/A where φ is said phase shift, and A=A₀*[(Xᵣ)²+(Yᵣ)²]^{0.5} where X₀ and Y₀ are coordinates of said reference vector.

104. A method according to claim 103, wherein:
said reference vector is chosen such that X₀=1 and Y₀=0.

105. A method according to claim 88, wherein:
said estimating further comprises reducing said differential quadrature components to obtain reduced differential components dYᵣₖₙ according to dYᵣₖₙ=(dYₖₙ cos Δₖₙ+dXₖₙ sin Δₖₙ), where Δₖₙ is a phase difference between said decision vector for the n-th symbol of the k-th carrier and a reference vector.

106. A method according to claim 105, wherein:
said estimating further comprises accumulating signs of the reduced components for each said carrier group.

107. A method according to claim 106, wherein:
said accumulating signs comprises accumulating said signs according to
$${D}_{+ -} = {\sum }_{k = 1}^{K} {\sum }_{n = 1}^{N} Sign ( {dY}_{kn} cos {Δ}_{kn} + {dX}_{kn} sin {Δ }_{kn} ) ,$$
where K is the number of carriers in a respective carrier group, N is the number of symbols over which averaging is done, Sign(x)=+1 or −1, and D₊₋ represents a difference between a number of components with positive phase shifts and a number of components with negative phase shifts in a carrier group and its sign determines a direction for frequency offset adjustment.

108. A method according to claim 107, wherein:
N is chosen such that KN is a desired value.

109. A method according to claim 108, wherein:
KN is chosen to be at least 50.

110. A method according to claim 107, wherein:
said estimating further includes comparing said D₊₋ to a predetermined threshold value T_{d}.

111. A method according to claim 110, wherein:
said estimating includes determining a frequency offset value for each carrier group as a function of an average offset of the majority components of that carrier group.

112. A method according to claim 110, wherein:
said estimating includes determining an adjustment direction Sign(φ) according to
$$Sign ( ϕ ) = Sign [ {\sum }_{k = 1}^{K} {\sum }_{n = 1}^{N} Sign ( {dY}_{kn} cos {Δ}_{kn} + {dX}_{kn} sin {Δ}_{kn} ) ] .$$

113. A method according to claim 86, wherein:
said estimating further comprises reducing said quadrature components to obtain reduced quadrature components Yᵣₖₙ according to Yᵣₖₙ=(Yₖₙ cos Δₖₙ+Xₖₙ sin Δₖₙ), where Δₖₙ is a phase difference between said decision vector for the n-th symbol of the k-th carrier and a reference vector.

114. A method according to claim 113, wherein:
said estimating includes accumulating signs of the reduced components for each said carrier group.

115. A method according to claim 114, wherein:
said accumulating signs comprises accumulating said signs according to
$${D}_{+ -} = {\sum }_{k = 1}^{K} {\sum }_{n = 1}^{N}$$
Sign (Yₖₙ cos Δₖₙ+Xₖₙ sin Δₖₙ), where K is the number of carriers in a respective carrier group, N is the number of symbols over which averaging is done, Sign(x)=+1 or −1, and D₊₋ represents a difference between a number of components with positive phase shifts and a number of components with negative phase shifts in a carrier group and its sign determines a direction for frequency offset adjustment.

116. A method according to claim 115, wherein:
N is chosen such that KN is a desired value.

117. A method according to claim 116, wherein:
KN is chosen to be at least 50.

118. A method according to claim 113, wherein:
said estimating includes comparing said D₊₋ to a predetermined threshold value T_{d}.

119. A method according to claim 118, wherein:
said estimating includes determining a frequency offset value for each carrier group as a function of an average offset of the majority components of that carrier group.

120. A method according to claim 118, wherein:
said estimating includes determining an adjustment direction Sign(φ) according to
$$Sign ( ϕ ) = Sign [ {\sum }_{k = 1}^{K} {\sum }_{n = 1}^{N} Sign ( {dY}_{kn} cos {Δ}_{kn} + {dX}_{kn} sin {Δ}_{kn} ) ] .$$

121. A method according to claim 85, wherein:
a first of said plurality of nodes utilizes a group of carriers including a first plurality of carriers and a second of said plurality of nodes utilizes a group of carrier including a second plurality of carriers different than said first plurality of carriers.

122. A method according to claim 85, wherein:
a first of said plurality of nodes utilizes a group of carriers including a single carrier and a second of said plurality of nodes utilizes a group of carrier including a plurality of carriers different than said single carrier.

123. A method according to claim 85, wherein:
said using said frequency offset parameters to implement frequency offset compensation in the time domain comprises utilizing an inverse fast Fourier transformer (IFFT) and a signal correction means coupled to the IFFT in each node for frequency offset compensation of data signals applied to and processed by the FFT.

124. A method according to claim 123, wherein:
said signal correction means corrects a data signal according to X_{mc}=Xₘ cos(mφ)+Yₘ sin(mφ), Y_{mc}=Yₘ cos(mφ)−Xₘ sin(mφ), where Xₘ and Yₘ are respectively real and imaginary parts of an m-th complex sample of said signal at an output of said IFFT after processing by said IFFT, where m is an integer changing from 1 to M, and M is the number of carriers in said multicarrier system, X_{mc} and Y_{mc} are respectively real and imaginary parts of the m-th corrected sample, and φ is a function of said indication of said frequency offset estimation sent by the hub to the node.

125. A method according to claim 85, further comprising:
having at least two of the plurality of nodes transmit on at least one same carrier for transmission but at different times.
